(19) United States
(12) Patent Application Publication
(10) Pub. No.: US 2023/0417279 A1
(43) Pub. Date: Dec. 28, 2023

(54) TAPERED ROLLER BEARING

(71) Applicant: AKTIEBOLAGET SKF, GOTEBORG (SE)

(72) Inventors: Thilo BECK, Schweinfurt (DE); Andreas BEUTLER, Zernien (DE); Helger HEMPEL, Nemt (DE); Henning KERN, Dittelbrunn (DE); Udo KRUG, Theres (DE); Peter LEMPER, Hitzacker (DE); Klaus-Dieter Schulz, Jameln (DE)

(21) Appl. No.: 18/035,558

(22) PCT Filed: Nov. 5, 2021
(86) PCT No.: PCT/EP2021/080742

§ 371 Date: May 5, 2023

(30) Foreign Application Priority Data
Nov. 18, 2020 (DE) 10 2020 130 456.0

(51) Int. Cl. F16C 19/36; F16C 33/36; F16C 33/60

(52) U.S. Cl. CPC F16C 19/364; F16C 33/366; F16C 33/60; F16C 2240/34; F16C 2240/70

(57) ABSTRACT

A tapered roller bearing having a diameter of less than 1.5 m includes an inner ring having at least one inner raceway, an outer ring having at least one outer raceway and at least one set of tapered rollers between the inner ring and the outer ring that are configured to roll on the at least one inner raceway and on the at least one outer raceway about a tapered-roller rotational axis while the tapered roller bearing is configured to rotate about a bearing rotational axis. An angle formed by the bearing rotational axis and the tapered-roller rotational axis is greater than 450 and is preferably between 500 and 55°.

The present invention relates to a tapered roller bearing according to the preamble of patent claim 1. Furthermore, the invention relates to a high-precision machine-tool table with such a tapered roller bearing.

For machine-tool tables, such as, for example, 5-axis milling machines, bearings are generally required that on the one hand can support radial and axial loads, as well as so-called moment loads that have been caused by a tipping of the bearing axis during the rotation, and on the other hand have a high running accuracy. In order to achieve the required running accuracy, corresponding manufacturing tolerances must be observed. Furthermore, machine-tool tables should be as stiff as possible since the elastic deformation under load has strong effects on the productivity and accuracy of the entire machine tool.

Machine-tool table applications often also require rolling-element bearings that support high rotational speeds. These requirements with regard to rotational speeds of machine-tool tables require fast-running rolling-element bearings. However, due to the increasing rotational speeds, the power loss thus caused, in particular the friction, can also increase. However, the increased friction leads to further effects, such as, for example, increased heating of the bearing, that can additionally negatively affect the accuracy.

It is therefore the object of the present invention to provide a tapered roller bearing suitable for high rotational speed applications in machine-tool tables.

This object is achieved by a tapered roller bearing according to patent claim 1, and a high-precision machine-tool table according to patent claim 13.

In the following, a tapered roller bearing, in particular a high-precision tapered roller bearing, in particular with a diameter of less than 1.5 m, is described, that includes an inner ring that includes at least one inner raceway, an outer ring that includes at least one outer raceway, the inner ring and the outer ring being rotatable with respect to each other, and at least one set of tapered rollers that are disposed between the inner ring and the outer ring and that roll on the at least one inner raceway and the at least one outer raceway about a tapered-roller rotational axis, wherein the tapered roller bearing is configured to rotate about a bearing rotational axis. The outer ring is preferably fixed, and the inner ring is preferably rotatable, and the tapered roller bearing is a double row tapered roller bearing. The tapered roller bearing is preferably a table bearing for a machine-tool table, preferably a high-precision machine-tool table.

In order to increase the tilt rigidity and thereby to improve the high precision of the proposed tapered roller bearing, and also to enable it to be used at high speeds (e.g. at rotational speed values of over 200,000 NDm), an angle that is formed between the bearing rotational axis and the tapered rotational axis is greater than 45°. The angle is preferably between 450 and 65°; most preferably, preferably between 500 and 55°. Here the tilt rigidity is influenced by the angle of the pressure lines of the rolling-element bearing with the bearing rotational axis. The farther the intersection points of the pressure lines with the bearing rotational axis are spaced from one another, the higher the tilt rigidity is of the bearing. In other words, the larger the angle, the more tilt-rigid the bearing. However, it must be taken into account in the definition of the bearing angle that the radial rigidity decreases the larger the angle is. The fixing at an angle between 450 and 650 thus represents an optimization between radial rigidity, axial rigidity, and tilt rigidity. A too-large angle would likewise also negatively influence the friction.

It should be noted that the above rigidities can depend among other things on the roller set and/or the diameter of the tapered roller bearing.

The term “high-precision tapered roller bearing” is understood in particular to mean that the tapered roller bearing achieves a radial and axial runout of tolerance class 4 or better according to ISO 492:2014, ISO 199:2014; or P4 or better according to DIN 620-2, DIN 620-3.

According to one embodiment, a guide flange for the guiding of the tapered rollers can be disposed on the outer ring, wherein the guide flange is formed one-piece with the outer ring. An exemplary embodiment is particularly preferred in which the outer ring and the guide flange are ground in a common process, i.e., simultaneously. The outer ring is preferably configured fixed. However, it is equally possible that the inner ring is configured fixed, and the outer ring is configured rotating.

The providing of the guide flange on a fixed outer ring has the advantage that the guide flange can be more easily lubricated and cooled since the fixed outer ring is more easily accessible, in particular from outside. Due to the better lubrication, the friction of the bearing can also be reduced at high rotational speeds. The simplified cooling also makes it possible to reduce the heating of the bearing. Due to the improved lubrication and the improved cooling, a performance of the bearing can be further improved.

The outer ring is preferably one-part. Alternatively or additionally, the inner ring can be two-part. Due to a one-part outer ring, the rigidity and also the accuracy of the bearing can be increased. The outer ring is preferably provided with a flange that extends toward the outer side of the tapered roller bearing, wherein a thickness of the flange in the axial direction is narrower than the bearing ring. The tapered roller bearing can thereby be designed more compact.

According to a further embodiment, the at least one inner raceway and/or the at least one outer raceway have a straight profile. A “straight profile” is understood in particular to mean that the profile is flat and does not have a crowned shape. In particular, a skewing of the tapered rollers can thereby be reduced, and the rigidity can be increased. The straight profile of the at least one inner raceway and/or of the at least one outer raceway is preferably embodied with a tolerance of 0 μm to 3 μm. Due to the tolerance, the straight profile of the at least one inner raceway and/or of the at least one outer raceway can become slightly crowned.

Furthermore, the tapered rollers can have a slightly crowned profile. Edge running can thus be reduced. A “crowned shape” is understood to mean a profile that has a curvature, in particular a convex curvature. A variation of the diameter, measured in the center of the tapered roller, of all tapered rollers of the tapered roller bearing is preferably less than 1 μm. The accuracy of the tapered roller bearing can thereby be further increased.

According to a further embodiment, an edge clearance between an edge of an end side of a tapered roller and of the inner raceway and/or of the outer raceway is less than 20 μm, preferably between 1 μm and 10 μm. It applies here that: The larger the edge clearance, the lower is the rigidity. The term “edge clearance” is understood in particular to mean a distance of the end side of the tapered roller to the raceway without load.

A ratio d/A of a diameter of the inner ring d and a spacing A of the geometric center points of the tapered rollers of the row is preferably smaller than 15, d/A<15, in particular falls between 8≤d/A≤12. In particular, the tilt rigidity of the system becomes higher the larger the spacing A is of the center points of the tapered rollers of the rows.

The tapered roller bearing preferably further includes a cage that is configured to hold and to guide the rolling elements. The cage can in particular be manufactured from a plastic material. Alternatively, the cage can also be manufactured from a metal. A cage can among other things simplify an installation of the rolling elements.

Furthermore, a high-precision machine-tool table with an above-described tapered roller bearing is proposed.

Further advantages and advantageous embodiments are specified in the description, the drawings and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

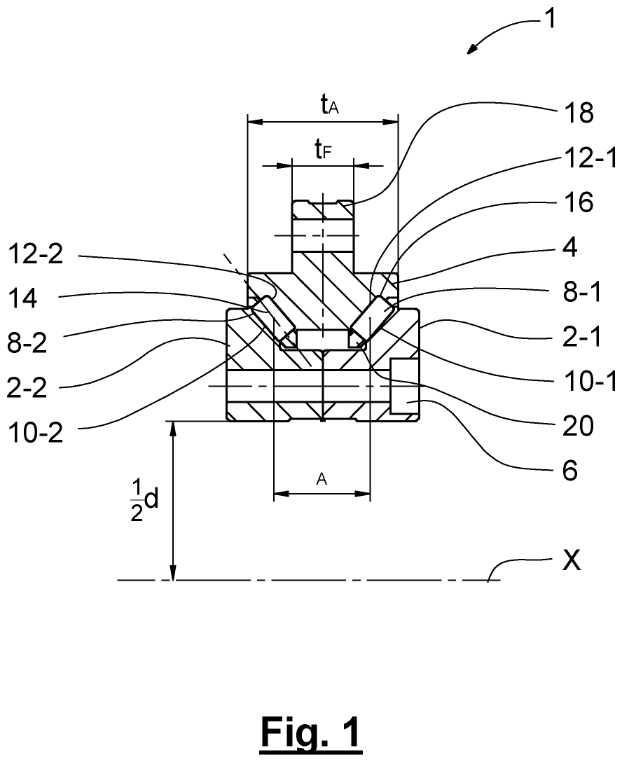

FIG. 1 shows a sectional view through a tapered roller bearing according to one embodiment, and

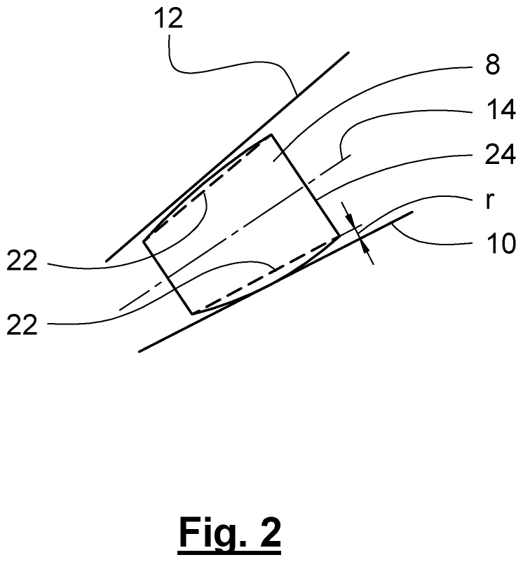

FIG. 2 shows a schematic view of a section of FIG. 1.

In the following, identical or functionally equivalent elements are designated by the same reference numbers.

FIG. 1 shows a tapered roller bearing 1 that includes an inner ring 2 and an outer ring 4, wherein the inner ring 2 is comprised of a first part 2-1 and a second part 2-2 that are connected to each other by an attachment means 6. The tapered roller bearing 1 has a diameter of less than 1.5 m.

In the tapered roller bearing 1 shown in FIG. 1, the outer ring 4 is fixed, whereas the inner ring 2 is designed to rotate about a rotational axis X. Alternatively, the outer ring 4 can also be configured rotating, and the inner ring can be configured fixed. The tapered roller bearing 1 can in particular be a high-precision tapered roller bearing.

Between the inner ring 2 and the outer ring 4, a set of tapered rollers 8 is disposed wherein the set of tapered rollers 8 roll on an inner raceway 10 associated with the inner ring 2 and on an outer raceway 12 associated with the outer ring 4. The tapered roller bearing 1 is preferably a double row tapered roller bearing, i.e., two sets of tapered rollers 8-1, 8-2 are provided that each roll on associated inner and outer raceways 10-1, 10-2, 12-1, 12-2.

In order to simplify the installation of the tapered rollers 8, the tapered roller bearing 1 can include a cage 20 that is designed to hold and to guide the tapered rollers 8. The cage 20 can in particular be manufactured from a plastic material. Alternatively, the cage 20 can also be manufactured from a metal.

In order to increase the tilt rigidity of the tapered roller bearing 1, in the tapered roller bearing 1 the raceways, i.e., the inner and outer raceways 10-2, 10-2, 12-1, 12-2, are configured such that an angle that is formed between the bearing rotational axis X and a tapered-roller rotational axis 14 of a respective tapered roller 12 is greater than 45°. The “tapered-roller rotational axis 14” is understood to mean the rotational axis about which the tapered roller 8 rotates. The angle that is formed between the bearing rotational axis X and a tapered-roller rotational axis 14 of a respective tapered roller 8 is preferably between 45° and 65°, most preferably between 50° and 55°.

Furthermore, a guide flange 16 is provided on the fixed outer ring 4. The guide flange 16 is formed one-piece with the outer ring 4 and configured to guide the tapered rollers 8. The outer raceways 12-1, 12-2 of the outer ring 4 are preferably formed by grinding, wherein the guide flanges 16 are simultaneously formed on the outer ring 4.

Furthermore, the outer ring 4 is provided with a flange 18 that extends toward the outer side of the tapered roller bearing 1. Here a thickness t_{F} of the flange is narrower in the axial direction than a thickness t_{A} of the outer ring 4. Furthermore, a ratio d/A of a diameter d of the inner ring 2 and a spacing A of the geometric center points of the tapered rollers 8 of the row is preferably smaller than 15, d/A<15, in particular falls between 8≤d/A≤12.

FIG. 2 shows a schematic depiction of a section of FIG. 1 in which the profiles of the inner raceway 10, of the outer raceway 12, and of the tapered roller 8 are shown. In the tapered roller bearing 1 of FIG. 1, the inner raceways 10-1, 10-2 and the outer raceways 12-1, 12-2 have a straight profile. A “straight profile” is understood in particular to mean that the profile is flat and does not have a crowned shape. In contrast thereto, the tapered rollers 8 have a slightly crowned profile, i.e., the profile has a slight, in particular a convex, curvature. This is indicated schematically in FIG. 2. The dashed lines 22 show a theoretical straight profile course, while the continuous lines show the slightly crowned course of the tapered roller profile.

In particular, an edge clearance r between an end surface 24 of the tapered roller 8 and the inner raceway 10 and/or the outer raceway 12 can be less than 20 μm, preferably between 1 μm and 10 μm.

In summary, a tapered roller bearing 1 is provided in which the angle formed between the bearing rotational axis X and the tapered-roller rotational axis 14 is greater than 45°. The tilt rigidity of the tapered roller bearing can thus be increased, whereby the high accuracy of the tapered roller bearing 1 is improved even at high rotational speeds.

### REFERENCE NUMBER LIST

1 Tapered roller bearing
2 Inner ring
4 Outer ring
6 Attachment means
8 Tapered roller
Inner raceway
12 Outer raceway
14 Tapered-roller rotational axis
16 Guide flange
18 Flange
20 Cage
22 Line
24 Edge of the tapered roller
A Spacing of the tapered roller rows
X Bearing rotational axis
t_{A} Thickness of the outer ring
t_{F} Thickness of the flange
d Diameter of the inner ring
r Edge clearance

1. A tapered roller bearing having a diameter of less than 1.5 m, comprising:
an inner ring having at least one inner raceway,
an outer ring having at least one outer raceway, the inner ring and the outer ring being rotatable with respect to each other, and
at least one set of tapered rollers disposed between the inner ring and the outer ring configured to roll on the at least one inner raceway and the at least one outer raceway about a tapered-roller rotational axis, the tapered roller bearing being configured to rotate about a bearing rotational axis,
wherein
an angle formed by the bearing rotational axis and the tapered-roller rotational axis is greater than 45°.

2. The tapered roller bearing according to claim 1, wherein the angle is between 45° and 65°.

3. The tapered roller bearing according to claim 1, wherein the outer ring includes a guide flange for guiding the tapered rollers, the guide flange being formed one-piece with the outer ring.

4. The tapered roller bearing according to claim 1, wherein the outer ring is one-part and the inner ring is two-part.

5. The tapered roller bearing according to claim 1, wherein the outer ring is fixed and the inner ring is rotatable.

6. The tapered roller bearing according to claim 1, wherein the outer ring includes an outer flange, and wherein an axial thickness of the outer flange is less than an axial thickness of the outer ring.

7. The tapered roller bearing according to claim 1, wherein the at least one inner raceway and/or the at least one outer raceway have a straight profile.

8. The tapered roller bearing according to claim 1, wherein the tapered rollers have a crowned profile.

9. The tapered roller bearing according to claim 1, wherein an edge clearance between an edge of an axial end side of each tapered roller and the inner raceway and/or the outer raceway is less than 20 m.

10. The tapered roller bearing according to claim 1, wherein the at least one set of tapered rollers comprises a first set of tapered rollers and a second set of tapered rollers axially spaced from the first set of tapered rollers.

11. The tapered roller bearing according to claim 10, wherein a ratio of a diameter of the inner ring and a minimum axial spacing of geometric center points of a tapered roller of the first set of tapered rollers and a tapered roller of the second set of tapered rollers is smaller than 15.

12. The tapered roller bearing according to claim 1, wherein a variance of a diameter measured at an axial center of each of the tapered rollers is less than 1 μm.

13. A high-precision machine-tool table with a tapered roller bearing according to claim 1.

14. The tapered roller bearing according to claim 1, wherein the angle is between 50° and 55°.

15. The tapered roller bearing according to claim 1, wherein an edge clearance between an edge of an axial end side of each tapered roller and the inner raceway and/or the outer raceway is between 1 μm and 10 μm.

16. The tapered roller bearing according to claim 10, wherein a ratio of an inner diameter of the inner ring and a minimum axial spacing of geometric center points of a tapered roller of the first set of tapered rollers and a tapered roller of the second set of tapered rollers is between 8 and 12.

17. The tapered roller bearing according to claim 1,
wherein the at least one inner raceway comprises a first inner raceway and a second inner raceway,
wherein the at least one outer raceway comprises a first outer raceway and a second outer raceway,
wherein the at least one set of tapered rollers comprises a first set of tapered rollers between the first outer raceway and the first inner raceway and a second set of tapered rollers between the second outer raceway and the second inner raceway,
wherein the angle is between 50° and 55°,
wherein the outer ring includes a first guide flange configured to guide the first set of tapered rollers and a second guide flange configured to guide the second set of tapered rollers,
wherein the outer ring includes an outer flange projecting away from the inner ring,
wherein an axial thickness of the outer flange is less than an axial thickness of the outer ring,
wherein the tapered rollers of the first and second sets of tapered rollers are crowned, and
wherein an edge clearance between an edge of an axial end side of each tapered roller and the inner raceway and/or the outer raceway is between 1 μm and 10 μm.

18. The tapered roller bearing according to claim 17,
wherein a ratio of an inner diameter of the inner ring and an axial spacing of a geometric center point of a tapered roller of the first set of tapered rollers and a geometric center point of a tapered roller of the second set of tapered rollers is between 8 and 12.
